(19) United States
(12) Patent Application Publication
(10) Pub. No.: US 2008/0258907 A1
(43) Pub. Date: Oct. 23, 2008

(54) Wireless detection and alarm system for monitoring human falls and entries into swimming pools by using three dimensional acceleration and wireless link energy data method and apparatus

(75) Inventor: Alex J. Kalpaxis, Glendale, NY (US)

Correspondence Address: VENABLE LLP, P.O. BOX 34385, WASHINGTON, DC, 20043-9998, US

(73) Assignee: 24/8 LLC, Waterbury, CT (US)

(21) Appl. No.: 12/076,364

(22) Filed: Mar. 17, 2008

Related U.S. Application Data
(63) Continuation of application No. 11/882,578, filed on Aug. 2, 2007, now abandoned.
(60) Provisional application No. 60/821,209, filed on Aug. 2, 2006.

(30) Foreign Application Priority Data
May 17, 2007 (US) PCT/US2007/011784

(51) Int. Cl. H04Q 7/00

(52) U.S. Cl. 340/539.1

(57) ABSTRACT

Disclosed is a method and apparatus for monitoring and analysis. The system (1000) includes a wireless detector (1040) within a body of water in combination with video cameras (1080) that surround a body of water. The wireless detector (130) sends acceleration data and the video cameras sends image data, both using a mesh-type wireless network, to a wireless Collector/Analyzer Server (1020). The Collector/Analyzer Server (1020) processes the received data and provides an alarm signal based on the results of comparisons of the different types of data to respective reference data. Image tracking video algorithms are used to create video fences around the swimming pool's perimeter and using this as the boundary conditions for creating an alarm criteria.

### PRIORITY

This application is a continuation application of U.S. application Ser. No. 11/882,578 filed Aug. 2, 2007 which claims priority to U.S. Provisional Application Ser. No. 60/821,209 filed Aug. 2, 2006, and to PCT Application Serial No. U.S. Ser. No. 07/011,784 filed with the International Bureau on May 17, 2007, which claims priority to U.S. Provisional Application Ser. No. 60/747,437 filed May 17, 2006, the entire content of all of the above are incorporated herein by reference.

### FIELD OF THE DISCLOSURE

The exemplary embodiments are directed to detecting motion in three dimensions. More particularly, the exemplary embodiments are directed to detecting acceleration data that results from motion resulting from a person's actions, such as falling into a swimming pool and causing the surface of the water to move, or the actual detection of the falling of the person.

### BACKGROUND

This disclosure relates to methods and apparatus for the wireless detection and alarm of human falls and entries into swimming pools. More specifically, this disclosure describes methods and apparatus for detecting and generating alarms when humans such as infants, small children, disable persons, or persons who cannot swim, fall or enter into a body of water, such as a filled swimming pool. The exemplary embodiments can monitor and detect falls or entries into a swimming pool by measuring three dimensional water wave acceleration motion vectors in real-time. Unique adaptive software signal processing algorithms that are executed by the exemplary embodiments are able to mask out normal environmental variations of wind-blown water waves and other motions that would create false event triggering. The exemplary embodiments wirelessly relay critical event data, such as falls into a filled swimming pool, to a data collector facility that can generate an alarm and can process an emergency dispatch call list. The exemplary embodiments can have no interaction from the monitored facility or individuals since the system can be autonomous in its critical event processing.

### SUMMARY

It is desirable to provide a method and apparatus for detecting human falls and entries into swimming pools. The detection and alarm system events via a preferably low-power, wireless, dome-shaped floatation device that would float freely in the to-be-monitored swimming pool. The flotation device can contain a Micro-controller Processor Unit (MPU), a Micro Electro Mechanical system (MEMS) based three dimensional accelerometer, and incorporates a wireless sensor network transceiver to communicate three-dimensional accelerometer motion data to a collection node. The collection node is an embedded collector analyzer server. Motion analysis software determines normal wind driven water wave motion versus water wave induced by a fall or unauthorized entry or versus on stable ground as a result, for example, of removal from the swimming pool to classify events. The aforementioned wireless floatation device and an embedded collector analyzer server are collectively referred to as the system. Besides detecting these events, the system is able to temporally log these events for purposes of notifying swimming pool attendant/observes, modify or create schedules, and training young swimming pool users.

It is an object of the disclosure to describe a method and apparatus to detect real-time human falls and entries into swimming pools motion events and relay these events wirelessly to an embedded collection server computer for alarm generation and further event processing.

It is a further object of the disclosure to describe a method and apparatus for wireless real-time measurement to three dimensional accelerometer motion vectors data generated by water waves for detecting human falls and unauthorized entries into swimming pools.

It is a further object of the disclosure to describe a method and apparatus for real-time profiling and correlating human falls and entries into swimming pools, which result in water wave motion events against those that result from environmental motion events such as normal wind-driven water waves to mask out false alarm events.

It is a further object of the disclosure to describe a method and apparatus for real-time/heuristic three dimensional accelerometer motion vector data gathering and processing to allow for the detection of wireless dome-shaped floatation device out-of-the swimming pool and on solid surface condition. In addition, when the wireless floatation device is in this state, it can remind the swimming pool owner with periodic alarms that the swimming pool is not being monitored.

It is a further object of the disclosure to describe a method and apparatus for three dimensional accelerometer motion vectors data gathering and processing using software algorithms that dynamically control digital range scaling for the acquisition of accelerometer data for enhancing signal processing.

It is a further object of the disclosure to describe a method and apparatus for detecting and analyzing three dimensional accelerometer motion vectors from water wave “groups” which are used as input to calculate differential acceleration time derivatives ([d(Ax)/dt]²+[d(Ay)/dt]²+[d(Az)/dt]²) using an algorithm for three dimensional water wave analysis and detection.

Another object of the disclosure is to provide a method and apparatus for generating alarm events as a result of the wireless dome-shaped floatation devices being too close to one another in a cluster which can reduce the effective monitoring and detection of human falls and entries into the swimming pool being monitored. This feature would provide alerts to the swimming pool owner/attendant to disperse the wireless dome-shaped floatation devices for better monitoring coverage.

Another object of the disclosure is to provide a method and apparatus for generating date and time stamped logs of alarm events for the purposes of modifying swimming pool attendant/observer schedules and training young swimming pool users.

Disclosed is a system for determining the occurrence of abnormal motion of a surface that includes a wireless motion detector for measuring three-dimensional acceleration motion data of the surface and wireless communications channel link energy data. A transmitter transmits the measured data to a receiver. The receiver receives and stores the data from the transmitter. A processor processes the data to determine whether the surface has experienced abnormal motion by signal averaging, temporally smoothing the received data using dynamically sized moving average convolution filters, and comparing the processed data with stored data. An output device outputs an indication of the occurrence of abnormal motion of the surface based on the comparison.

Also disclosed is a method for detecting entry of a person into a body of water by determining a condition of the water that indicates the entry of a person into the body of water. The method comprises the steps of measuring the three dimensional acceleration data of a device in the body of water and the device communications channel link energy with other devices and/or a server. The measured acceleration data is transmitted to a processor. The processor processes the transmitted data by signal averaging and temporally smoothing the transmitted acceleration data using dynamically sized moving average convolution filters. Differential acceleration time derivatives are created from the processed data. The created differential acceleration time derivatives are compared to historical profiles including differential acceleration time derivatives that relate to conditions that indicate the entry of a person into a body of water. Based on the results of the comparison, an indication of the entry of a person into the body of water is provided.

These and other objects of the disclosure are achieved by the exemplary method and apparatus herein described and are readily apparent to those of ordinary skill in the art, upon review of the following drawings, detailed description and claims.

### BRIEF DESCRIPTION OF THE DRAWINGS

The manner that the above recited and other advantages and objects of the invention are obtained, a more particular description of the preferred embodiments, which is illustrated in the appended drawing, is described. The reader should understand that the drawings depict only exemplary embodiments, and are not to be considered as limiting in scope.

A brief description of the drawings areas follows:

FIG. 1 is an exemplary process flow chart showing the information flow and processing steps of the wireless data collection method;

FIG. 2 is an exemplary time-series plot demonstrating the exemplary differential acceleration time derivatives;

FIG. 3 illustrates a simplified, exemplary high-level block diagram of the process flow between a wireless device and an embedded collector analyzer server;

FIG. 4 illustrates the exemplary process steps taken after system initialization;

FIG. 5 illustrates the an exemplary interrupt-driven software architecture for the wireless device microcontroller processing unit;

FIG. 6 is an exemplary sequence diagram of a transmission of acceleration data (Ax, Ay, Az) from the wireless device;

FIG. 7 illustrates the exemplary internal subsystems of the embedded Collector/Analyzer Server;

FIG. 8 illustrates an exemplary block diagram of this eleventh-order filter;

FIG. 9 illustrates an exemplary block diagram of this n^{th}-order filter;

FIG. 10 illustrates an exemplary embodiment of the disclosed system;

FIG. 11 illustrates network topologies that can be used to implement the disclosed system;

FIG. 12 illustrates an exemplary network implementation of the disclosed system; and

FIG. 13 illustrates another exemplary network implementation of the disclosed system.

Reference will now be made in detail to exemplary embodiments, examples of which are illustrated in the accompanying drawings.

### DETAILED DESCRIPTION

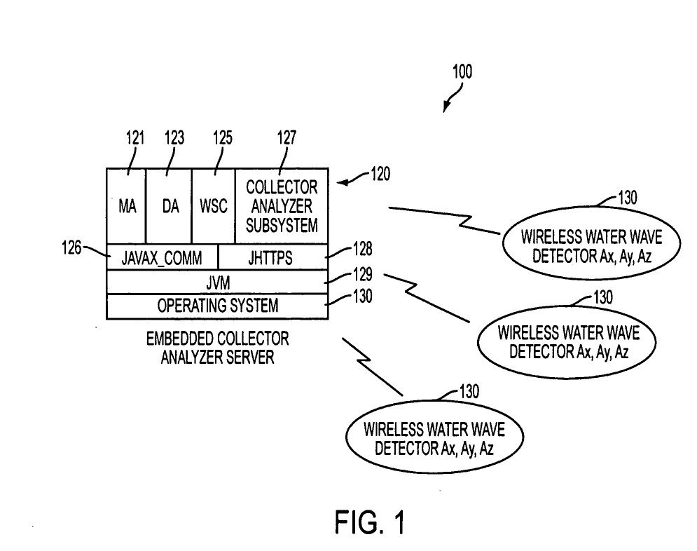

FIG. 1 is an exemplary process flow chart showing the end-to-end processing steps of the wireless water wave detector to the embedded collector analyzer server.

The wireless water wave detector is placed in the swimming pool that is to be monitored. The water ware detector contains three accelerometers, one for each dimension X, Y and Z used to measure motion. Besides detecting major critical events such as falls into a swimming pool, detector system profiles and correlates the temporal dynamics of normal background wind driven water waves for purposes of masking false alarms and alerts.

An embodiment implements a unique differential acceleration time derivative algorithm with heuristic functionality. The output of the acceleration axis is sampled with a 10-bit Analog Digital Converter (ADC). This 10-bit ADC is contained in the wireless water wave detector micro controller, which integrates the sampled data and feeds it to the wireless water wave detector core processor.

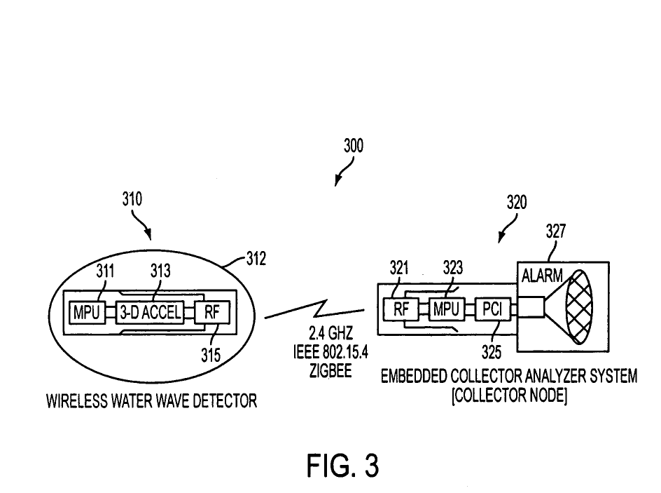

FIG. 3 is a block diagram illustrating a block diagram of a wireless water wave detector 310 and a Collector/Analyzer Server 320. The wireless water wave detector 310 preferably comprises a waterproof enclosure 312, a microcontroller processing unit 311, three dimensional accelerometers 313, and a radio frequency (RF) link 315. The wireless water wave detector 310 using the three dimensional accelerometers 313 preferably measures multiple acceleration vectors, for example, temporal three dimensional acceleration data (Ax, Ay, Az), multiple times (e.g., 3-6) every second. The measured vectors represent movement in each of the three dimensions of possible movement. Preferably, at least three to six vectors per second will be measured. These acceleration vectors are cached by microcontroller 311 and sent via a wireless RF link 315, for example, an IEEE 802.15.4 link, to the Collector/Analyzer Server 320, preferably at least once per second. The sent signals are received by the RF link 321 of the Collector/Analyzer Server 320. The signals are preferably 2.4 Ghz IEEE 802.15.4 ZigBee compliant signals. Although, other signals frequencies and formats can be used. The acceleration vectors are preferably signal averaged using weighted and/or not-weighted dynamically sized, moving average convolution filters, and used to determine distances traversed in each axis. Further analysis is performed by the Collector/Analyzer. Server 320 to determine human generated water wave disturbances versus normal wind driven water wave motion in a swimming pool, and is used as an input to calculate the differential acceleration time derivative ([dA/dt=v∥d(Ax)/dt]²+[d(Ay)/dt]z+[d(Az)/dt]²∥, where v represents velocity) contained within Collector/Analyzer Server 320 for three dimensional motion detection.

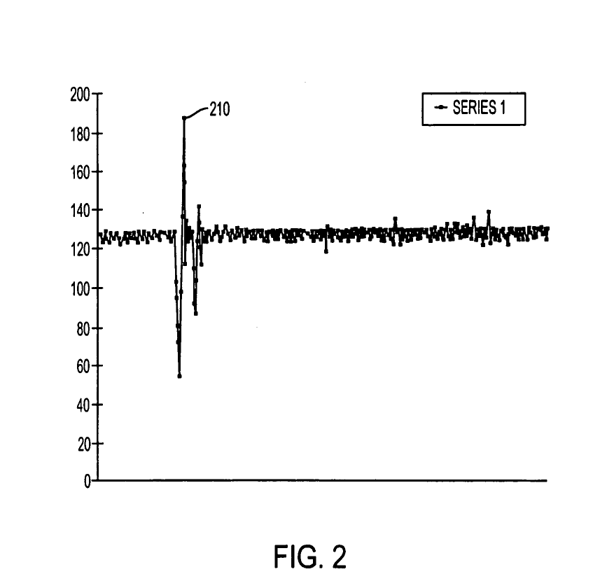

FIG. 2 is a plot of the wireless water wave detector 130 reported time-series acceleration data as processed by the Collector/Analyzer Server 120. These time-series plots are archived at the Collector/Analyzer Server 320 or some other data storage for further analysis such as profiling, event capture, group correlation of water wave events as required by the application. In FIG. 2, the plot indicates an exemplary fall into the swimming pool event 210 (i.e., the exemplary large signal spike) with the vertical axis depicting acceleration in acceleration of gravity units (g=9.8 meters/sec²) (128 units on y-axis=0 g, 255=+1.5 g, 0=−1.5 g) and the horizontal axis depicting time, for example, in seconds.

The Collector/Analyzer Server 320 will generate alarms, such as flashing lights or audible alerts to inform the swimming pool owner, operator or observer of the swimming pool event 210. The determination of whether an alarm or alert should be generated is based on minimum/maximum threshold for acceleration, the number of occurrences, duration of events indicating a fall into the swimming pool such as excessive splashing, and other factors can be accounted for to distinguish falls into the swimming pool by a human from normal relative activity. Relative meaning activity relative to the particular swimming pool environment, which is being monitored by the system. Although, historical cross-population (i.e., data from multiple swimming pools) data can be used as well.

Referring back to FIG. 1, for data reliability, the system 100 preferably uses the wireless IEEE 802.15.4 ZigBee mesh network technology standard for protection against failure. However, any known means of sending the data wirelessly from the water wave detector 130 to the Collector/Analyzer server 120 can be used. By placing the wireless water wave detectors 130, which contain the ZigBee receivers and transmitters, in groups, a mesh network is created. The groups or detectors can be any number of detections 130 spread around a swimming pool to provide adequate monitoring of the pool. A mesh network provides redundant paths to ensure redundant data path routes exist and there is no single point of failure should a node fail (i.e., a detector 130). A node can be a detector 130 or server 120. Wireless IEEE 802.15.4 ZigBee routers, which can be implemented within the water wave detector 130 preferably having extra specialized software running in the node are used to extend the range of the network by acting as relays for nodes that are too far apart to communicate directly. Of course, other technology and standards can be used. Additionally, water wave detector 130 dispersed within a swimming pool can act as relay nodes for other water wave detector 130 for purposes of relaying data to the Collector/Analyzer server 120. The system 100 uses this wireless technology standard for communication between the wireless water wave detector 130 and the Collector/Analyzer Server 120.

The wireless data communications preferably implement a 128-bit Advanced Encryption Standard (AES) algorithm for encryption and preferably incorporates all of the security features contained within the IEEE 802.15.4 standard. The security services implemented preferably include methods for key establishment and transport, device management and frame protection. The system leverages the security concept of a “Trust Center.” The “Trust Center” allows system node devices into the network, distribute keys and enables end-to-end security between the wireless water wave detectors 130 and Collector/Analyzer Server 120.

A management agent (MA) 121 is a system component monitor and reporting agent which relays process execution information for analysis. The deployment agent (DA) 123 is used to install and deliver system components for system code change management. The MA 121 and DA 123 work in concert to create and allow for managing the system. The web service communication (WSC) module 125 is the communication subsystem that supports web services, which has a publish/subscribe middleware software architecture. The Java extended communication subsystem (Javax_comm) 126 provides additional interface support beyond the main TCP/IP communication protocol Java supports generically. This includes extensions like USB, IEEE Firewire, and high-speed RS232.

The Collector Analyzer subsystem 127 performs the processing and analysis of the data received from the devices 130, the management of the devices 130, as well as communicating the results of the analysis to the necessary indicating devices. The functions and operations of the Collector Analyzer subsystem 127 will be discussing in further detail below.

The Java secure HTTP protocol communication subsystem 128 is a portion of a Java TCP/IP communication system that supports HTTPS, which is a Secure Socket Layer (preferably, SSL 3.0) implementation. It is used when users perform e-commerce transactions via an Internet web browser when the secure lock appears in the menu bar. The Java Virtual Machine (JVM) 129 is well known in the art as defined in the literature known to those of ordinary skill in the art.

Wireless Water Wave Detector Hardware

Referring back to FIG. 3, the wireless water wave detector 310 preferably uses a IEEE 802.15.4 compliant, 2.4 GHz Industrial, Scientific, and Medical (ISM) band Radio Frequency (RF) transceiver. It contains a complete 802.15.4 Physical layer (PHY) modem designed for the IEEE 802.15.4 wireless standard, which supports peer-to-peer, star, and mesh networking. It is preferably combined with an MPU 311 to create the required wireless RF data link and network. The IEEE 802.15.4 transceiver supports 250 kbps O-QPSK data in 5.0 MHz channels and full spread-spectrum encode and decode.

All control, reading of status, writing of data, and reading of data is done through the RF transceiver interface port. The wireless water wave detector MPU 311 accesses the wireless water wave detector RF transceiver 315 through interface “transactions” in which multiple bursts of byte-long data are transmitted on the interface bus. Each transaction is preferably three or more bursts long depending on the transaction type, although shorter bursts can be used. Transactions are preferably read accesses or write accesses to register addresses. The associated data for any single register access is preferably 16 bits in length.

Receive mode is a state where the wireless water wave detector RF transceiver 315 is waiting for an incoming data frame. The packet receive mode allows the wireless water wave detector RF transceiver 315 to preferably receive a whole packet without intervention from the water wave detector MPU 311. The entire packet payload is preferably stored in RX Packet RAM, and the microcontroller fetches the data after determining the bit length and validity of the RX packet.

The device RF transceiver 315 waits for a preamble followed by a Start of Frame Delimiter. From there, the Frame Length Indicator is used to determine length of the frame and calculate the Cycle Redundancy Check (CRC) sequence. After a frame is received, the wireless water wave detector MPU 311 determines the validity of the packet. Due to noise, it is possible for an invalid packet to be reported with either of the following conditions: A valid CRC and a frame length (0, 1, or 2) and/or invalid CRC/invalid frame length.

The wireless water wave detector MPU 311 software application determines if the packet CRC is valid, and that the packet frame length is valid with a value of 3 or greater. Of course, this value threshold can be greater than or less than 3. In response to an interrupt request from the device RF transceiver 315, the wireless water wave detector MPU 311 preferably determines the validity of the frame by reading and checking valid frame length and CRC data. The receive Packet RAM register is accessed when the device RF transceiver is read for data transfer.

The wireless water wave detector RF transceiver 315 preferably transmits entire packets without intervention from the wireless water wave detector MPU 311. The entire packet payload is preferably pre-loaded in TX Packet RAM, the wireless water wave detector RF transceiver 315 transmits the frame, and then transmits a complete status is sent for the wireless water wave detector MPU 311. When the packet is successfully transmitted, a transmit interrupt routine that runs on the device MPU 311 reports the completion of packet transmission. In response to the interrupt request from the device RF transceiver 315, the device MPU 311 reads the status to clear the interrupt, and check for successful transmission.

Control of the device RF transceiver 315 and data transfers are preferably accomplished by means of a Serial Peripheral Interface (SPI) with the MPU 311. Although the normal SPI protocol is based on 8-bit transfers, the device RF transceiver 315 imposes a higher level transaction protocol that is based on multiple 8-bit transfers per transaction. A singular SPI read or write transaction preferably comprises an 8-bit header transfer followed by two 8-bit data transfers. The header preferably denotes access type and register address. The following bytes are read or write data. The SPI also supports recursive ‘data burst’ transactions in which additional data transfers can occur. The recursive mode is intended for Packet RAM access and fast configuration of the device RF transceiver 315.

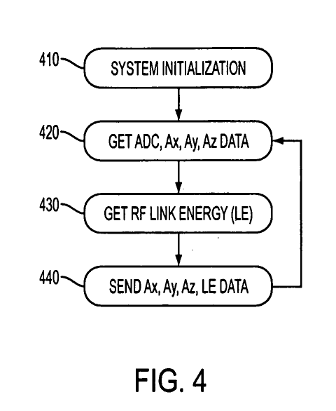

FIG. 4 illustrates exemplary process steps taken after system initialization. After system initialization (step 410), any acceleration data (Ax, Ay, Az) cached in memory at the wireless device is A/D converted and transmitted to the Collector/Analyzer Server at step 420. The wireless device forwards the link energy to the Collector/Analyzer Server at step 430. Finally, the Collector/Analyzer Server retrieves the sent A/D converted data and processes it (step 440) and the process repeats.

Wireless Water Wave Detector Software

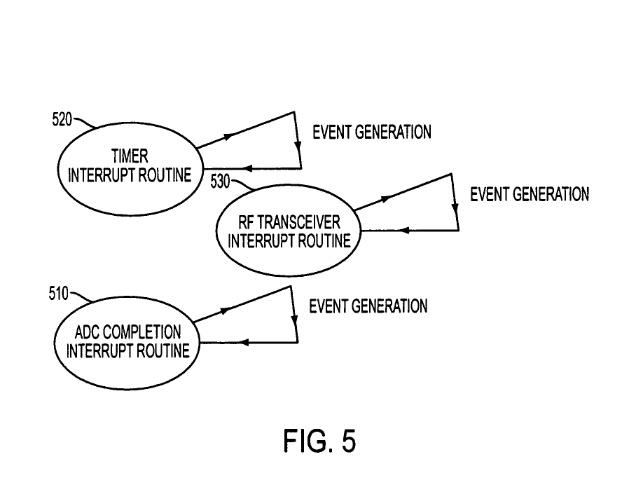

The software architecture for the wireless water wave detector MPU 311 uses an exemplary interrupt-driven architecture as shown in FIG. 5. The interrupt routines preferably include the reading of the Analog Digital Converter (ADC) 510, timers for creating the sampling frequency 520 and handling interrupts from the IEEE 802.15.4 RF Transceiver 530. Non-interrupt routines run on the device's MPU 311 are system initializations and the wireless communications to the collector analyzer server 520.

There a number of interrupt handlers that process data asynchronously from the non-interrupt main loop routine. The first is the ADC interrupts routine 510 which occurs when the conversion of the three analog acceleration vectors Ax, Ay, Az to digital is complete. The routine formats the ADC readings for reading by the non-interrupt main processing loop. The second is the Timer interrupt routine 520 which is used as a time base and generates the sampling rate frequency used by the ADC. The third is the wireless water wave detector's RF transceiver status and data transfers interrupt handler 530. This routine is used to process the wireless water wave detector's RF transceiver events, transmit acceleration (Ax, Ay, Az) data, link energy data via wireless water wave detector's RF transceiver to the Collector/Analyzer Server, and receive control/acknowledgement data via the wireless water wave detector's RF transceiver from the Collector/Analyzer Server.

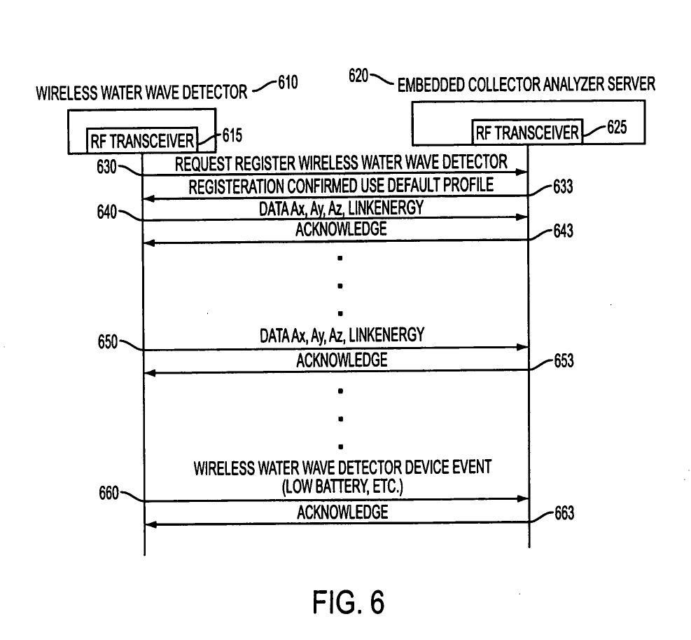

FIG. 6 is an exemplary sequence diagram of a transmission of acceleration data (Ax, Ay, Az) from the wireless water wave detector 610 to the Collector/Analyzer Server 620. The Collector/Analyzer Server 620 software is preferably a multithreaded Java-based server that handles one or more wireless water wave detector 610 communications channels for data gathering/control and secure Internet communications with a medical managed service provider(s). The Java language was chosen so as to provide the broadest base of support for Collector/Analyzer Server hardware platform. Of course, other programming languages can be used.

Transmission of the acceleration data from wireless water wave detector 610 is accomplished via a hand shaking procedure between the wireless water wave detector 610 and the Collector/Analyzer system 620. Acceleration and other data are transmitted via the RF transceiver 615 from the wireless water wave detector 610 to the Collector/Analyzer system 620. The Collector/Analyzer system 620 receives the transmitted data from the wireless water wave detector via its RF transceiver 625. As an initial matter, wireless water wave detector 610 sends a request register wireless water wave detector signal 630 to the Collector/Analyzer system 620. Upon successful registration, a signal is returned to the wireless water wave detector 610 from the Collector/Analyzer system 620. This signal is a registration confirmed use default profile signal 633. The wireless water wave detector 610 will then begin collecting data based on the default profile for the specific swimming pool being monitored. The wireless water wave detector 610 forwards three-dimensional acceleration data and link energy signals 640. The Collector/Analyzer system acknowledges this data via acknowledge signal 643. The transfer of data continues as shown by signal 650 from the wireless water wave detector 610. Receipt of the data is continually acknowledged by the Collector/Analyzer system 620 as illustrated by acknowledge signal 653. In the case of a low battery or similar type of occurrence, wireless water wave detector 610 sends a wireless water wave detector event signal 660, which indicates to the Collector/Analyzer system 620 that a wireless water wave detector event has occurred. Receipt of this message is acknowledged as illustrated by acknowledge message 663.

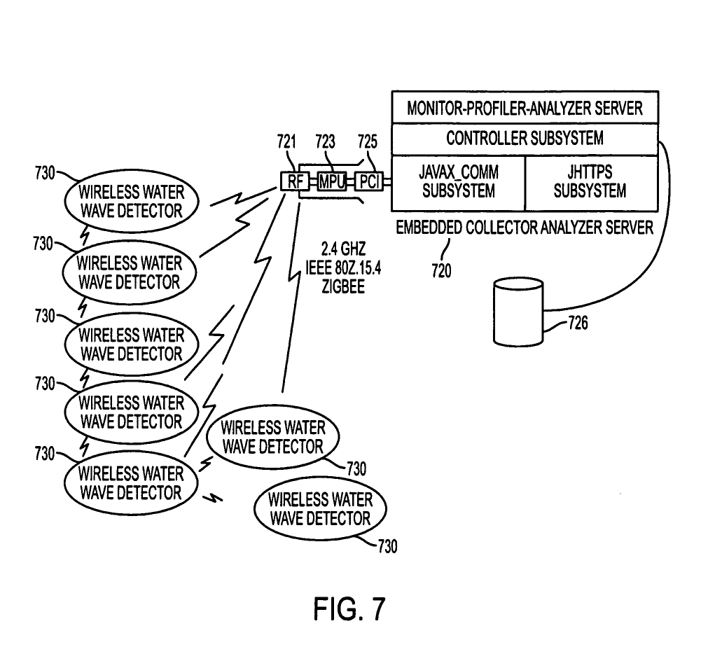

FIG. 7 illustrates the internal subsystems of the embedded Collector/Analyzer Server 720. The embedded Collector/Analyzer Server 720 collects wireless water wave detector 930 three-dimensional acceleration data (Ax, Ay, Az) with the signal strength (Link energy) associated with the wireless communications channel between the wireless water wave detector 730 and the embedded Collector/Analyzer Server 720. The wireless water wave detector 730 collects three dimensional acceleration data, which preferably is sampled a minimum of three to five times a second for each dimension. The data reflects the motion dynamics experienced by the wireless water wave detector 730 in real-time. The link energy signal is an indication of the signal strength associated with the wireless communications channel between the wireless water wave detector and the Collector/Analyzer system as well as between a first wireless wave detector and other wireless wave detectors.

Once receiving the wireless water wave detector 730 three-dimensional acceleration data, the embedded Collector/Analyzer Server 720 will perform normalization functions on the acceleration data to remove zero gravity (g) offsets. The embedded Collector/Analyzer Server 720 applies several signal averaging and Finite Impulse Response (FIR) filtering algorithms to the acceleration data for smoothing and signal noise reduction. This processed acceleration data represents a time-series of dynamic events which are reordered and/or analyzed for events related to humans falling into swimming pools and normal wind-driven water waves.

The embedded Collector/Analyzer Server 720 has numerous differential acceleration templates (for example, [d(Ax)/dt]²+[d(Ay)/dt]²+[d(Az)/dt]²) in memory that profile the changes in acceleration data that exist when human bodies fall into swimming pools, when the water of the pool experiences wind-driven water waves and when the wireless water wave detectors are out of the swimming pool and are on a stationary, stable surface. These templates are used to correlate the real-time acceleration data from the wireless water wave detector with known events such as when human bodies fall into swimming pools, when the water of the pool experiences wind-driven water waves and when the wireless water wave detectors are out of the swimming pool and are on a stationary, stable surface contained in the differential acceleration templates. When the embedded Collector/Analyzer Server 720 detects a human falling into the pool (or any other significant event), it immediately generates an alarm or alert or both to notify the swimming pool owner, operator or observer. In an exemplary embodiment, the embedded Collector/Analyzer server 720 identifies the particular wireless water wave detector 730 that generated the alarm or alert or both.

The embedded Collector/Analyzer Server 720 archives data locally in database 726, which allows for analyzing specific situations like scheduled and unscheduled swimming pool usage. The wireless water wave detectors can also be used as an alarm system to detect unauthorized entry into the swimming pool.

The embedded Collector/Analyzer Server 720 is designed with layered software architecture that preferably supports multithreading for concurrent processing of wireless bracelets, real-time data analysis, event processing, and medical managed service provider communication. The embedded Collector/Analyzer Server 720 preferably runs on a Java Virtual Machine (JVM) architecture so as to support a broad range of computing platforms.

The embedded Collector/Analyzer Server 720 software preferably uses as a default Finite Impulse Response (FIR) filter that is implemented using a eleventh-order moving average convolution filter whereby the filter coefficients are found via:

B(i)=1/(P+1) for i=0,1,2, . . . P

Where P=10 for creating the eleventh-order filter. The impulse response for the resulting filter is:

h(n)=δ(n)/11+δ(n−1)/11+δ(n−2)/11+δ(n−3)/11+δ(n−4)/11+δ(n−5)/11+δ(n−6)/11+δ(n−7)/11+δ(n−8)/11+δ(n−9)/11+δ(n−10)/11+δ(n−11)/11

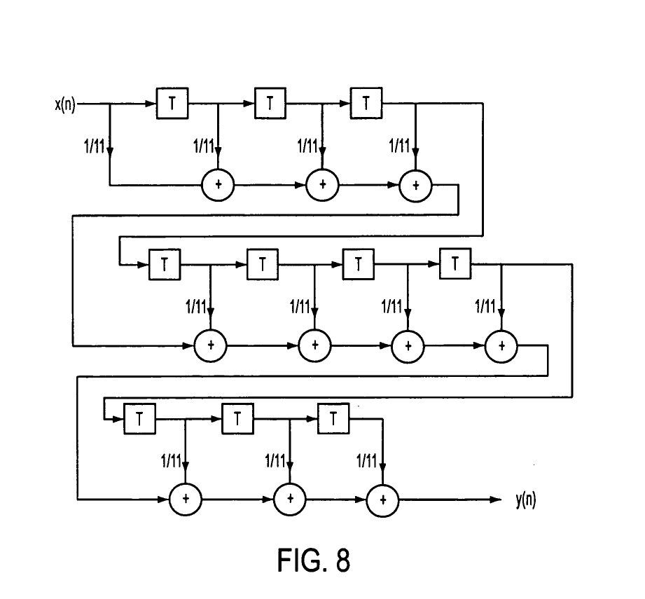

FIG. 8 illustrates the block diagram of this eleventh-order filter.

The Collector/Analyzer Server 720 software also uses a dynamic sized (ordered) Finite Impulse Response (FIR) filters based on profiling requirements that are implemented using n^{th}-order moving average convolution filters whereby the filter coefficients are found via:

B(i)=1/(P+1) for i=0,1,2, . . . P

Where P=n−1 for creating the n^{th}-order filter. The impulse response for the resulting filter is:

h(t)=δ(t)/n+S(t−1)/n+δ(t−2)/n+ . . . +δt−n)/n

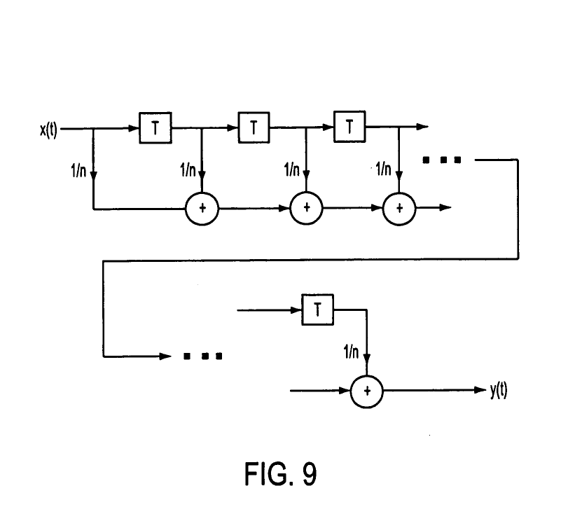

FIG. 9 illustrates the block diagram of this n^{th}-order filter.

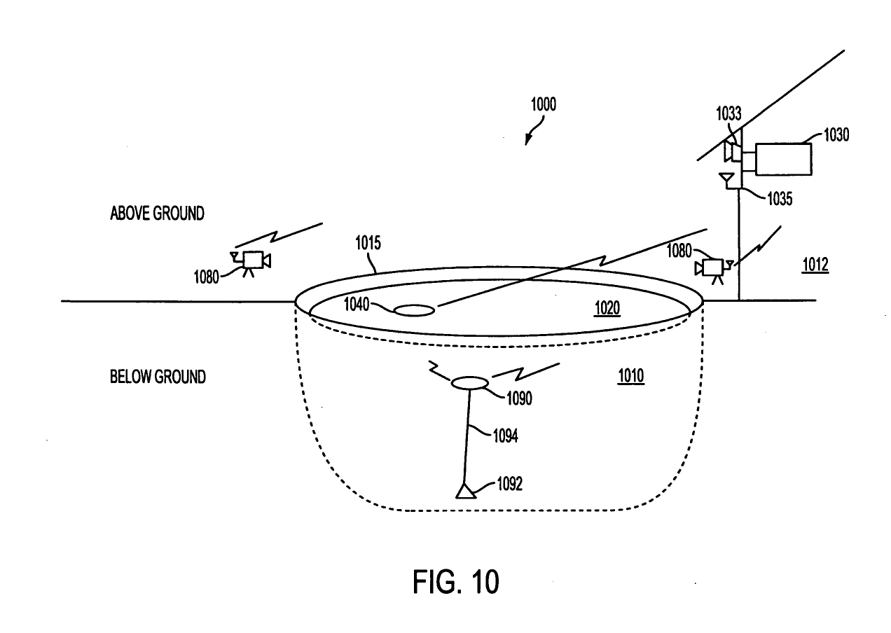

FIG. 10 illustrates exemplary embodiments of the disclosed system. The system 1000 is shown implemented in a swimming pool 1010 and a structure 1012, such as a residence, apartment complex clubhouse, community locker room, and the like. The edge of the pool 1015 is shown for visual reference. The system 1000 comprises a water wave detector 1040 or 1090, video cameras 1080 and a server 1030.

Water wave detector 1040 is shown floating on the surface 1020 of the water in the swimming pool 1010. The water wave detector 1090 is shown in another embodiment. The water wave detector 1090 is a submersible unit that lies beneath the surface 1020 of the water at a depth that allows for wireless communication with the server 1030. The water wave detector 1090 is kept submerged via attachment by a tether 1094 to an anchor 1092.

The server 1030 comprises a means to receive, such as an antenna, 1035 the data transmitted from the water wave detector 1040, 1090 and an alarm means such as a horn or light or some other device 1033. The means to receive 1035 can be the means an RF transceiver 321 as shown in FIG. 3. The alarm means can be alarm 327 also as shown in FIG. 3.

Exemplary embodiments of the system to monitor a body of water can either use only the water wave detectors 1040 and 1090, the video cameras 1080, or a combination of both.

In an exemplary embodiment, a series of video cameras 1080 are used to form a video “fence” around the perimeter of a swimming pool or other body of water frequented by people. Video cameras 1080 preferably capture digital images of persons around the swimming pool perimeter. The video cameras 1080 are preferably arranged so the entire perimeter of the body of water to-be-monitored is viewable by the video cameras 1080, and in such a number that any subject captured in the video frame is identifiable as explained in greater detail below.

In this embodiment, the water wave detectors 1040 and the video cameras 1080 can act as system monitor network nodes. The video cameras 1080 forward captured image data to the server 1020 that preferably contains video analytics algorithms that are based on modified Principle Component Analysis techniques, which is described in further detail below. The server 1020 image detector analyzes images obtained from a frame of the data captured by the digital video camera to derive at least a single person's, preferably a child's, image from the image. If there are multiple child images in the image frame, the server 1020 image detection algorithm will select the largest (based, for example, on number of pixels that comprise the child's image) of these child images. The child's image is then morphed in order to have regularized feature locations, i.e., so the normal alignment of eyes-nose-mouth is known. Although, the present embodiment is described with respect to images of children, the person could be any person, such as an elderly person or a disabled person.

The system can have two modes: a learning mode and a recognition mode. In learning mode, the system is collecting data from a person's image and processing that image using the image detection algorithm. The processed data is stored for future reference. In recognition mode, the system is recognizing persons from the person's image that-is collected from the video cameras 1080. However, the system is preferably recognizing at least two features of the image frame: 1) whether a child is in the image frame, and 2) whether the image frame has more than one person in the image. The second feature of the number of people is further refined to determine whether the more than one person comprises at least one adult or one person not previously stored in the system database.

The learning mode which is when the system is learning about a new child's image, in more detail, the system determines if the current child's image is different because of the pose (i.e., the child's head is turned slightly away from a frontal view), yet similar enough to an images already stored for that children image. If this is the case, the image is added to the collection of images for that particular child's image. Thereby increasing the amount of reference data for the particular child, which can increase the probability of matching in later encounters with that child, and reducing the number of false positives. The system can be trained by incorporating a previously captured image of the child's face, for example, from a memory device from a digital camera, in which case the server would have an interface for user input such as a reader.

If the system is not learning, then the system is in child recognition mode. Actual child images are stored in a decomposed list of Principle Component Values (PCV) for the child's image. The child's image is taken, decomposed into its principle component values, resulting in the “eigenchild's” image (a unique representation of the child's image based on eigenvalues associated with the image of the child), and used to determine the best match to the eigenchild's image to that stored in the system video camera image database in mass storage.

The closest child's-image, based on a predetermined distance, which can be related to the eigenchild values, of the child's image template stored in the system image database as compared to the real-time captured child's image for recognition. A least-squares technique is used to determine if the distance of the best matched child's template image and query child's image is less than a predetermined threshold, preferably three sigmas, as it relates to the least-squares-fit comparisons between image template and target image as a statistically weighted result set collection. If this is the case, the k-nearest neighbors of the query child's image are checked to determine if they all belong to the same person as the best match. The k-means clustering is used to classify or to group image objects based on attributes/features into K number of groups where K is positive integer number.

The grouping is done by minimizing the sum of squares of distances between data and the corresponding cluster centroid, which preferably uses K-mean clustering to classify the data. Once a confirmation of the distance is made, the child's image is recognized. To keep track of the system images and floating point arrays that represent the PCV, several array data-structures are created. A first array contains the records, loads them, stores them, associates them with a child's image, and keeps track of child's image detected statistics. Another array is used to point into the first array in order to allow rapid nearest neighbor and k-nearest neighbor searching. The array of data-structures has a Record per image that contains an image depending on whether or not the image was resident, along with the PCV, the eigenchild's image, associated with the image. Each child's image has one RecordCluster that is filled with a given number of images. RecordClusters are responsible for the management of a given child's image's data in its entirety and contain the actual data. The image database manger is responsible for loading images into the database and rapidly getting child's image data. The child image database manages an array of pointers to all of the learned child images and are arranged in a known manner, e.g., a sorted order or indexed, for rapid lookup.

On a initial level, image vector classes are used to store all facial records in the child image database. For a nearest neighbor (child's image) lookup, all elements in the image vector are analyzed and the sums-squared distance between the query child's image to each eigenchild's image in the system child image database are calculated. The record with the minimum distance preferably is returned. For the k-nearest neighbors, the distance for each eigenchild's image to the query child's image is calculated in one pass, then the vector is sorted in order to return the k shortest distances.

For child and object tracking, the video analytics operate on a two-dimensional color probability distribution image produced from histogram back-projection. The system child tracking video analytics are designed for dynamically changing distributions.

The dynamically changing distributions occur when objects in video sequences are being tracked and the object moves so that the size and location of the probability distribution changes in time. The child tracking video algorithm adjusts the search window size in the course of its operation. Initial window size is set to an initial value. For discrete distributions (digital data), the minimum window length or width is preferably three. Of course, larger or smaller-window lengths and widths can be used. Instead of a set, or externally adapted window size, the system child tracking video algorithm relies on zero moment information, extracted as part of the internal operation of the system child tracking video algorithm, to continuously adapt its window size within or over each video frame.

In this embodiment, the zero moment information is used to determine orientation and position of an object in an image. This is done by using the image pixels as a binary set of data where the pixels of the image of the object of interest are set to 1 and the background pixels are set to 0 (zero). The output consists of the positions of centroids (x, y) and the orientations of the objects in the range of (minus) −90 and +90 degrees (angle). The analysis for determining the centroid and orientation of an object use a moment function such as x=M (10)/M(01), y=M(01)/M(00), where M(00) is the zero moment, M(10) and M(01) are first moments.

When searching an image frame for a child, the system child tracking video algorithm sets the calculation region of the probability distribution to the whole image. A choice is made on the initial location of the two-dimensional search window. Next, the color probability distribution in the two-dimensional region centered at the search window location in an region-of-interest (ROI) slightly larger than the window size is calculated. Then the search window center is found and the zero moment (area or size) and center location are stored. With the next video frame, center the search window at the mean location stored before and set the window size to a function of the zero moment found there and calculated color probability distribution in the two-dimensional region centered at the search window location in an ROI slightly larger than the window.

The system child tracking video algorithm will compare current mobility in a region with a set perimeter boundary set at the system initialization process upon initial installation. This allows the system network nodes, i.e., video cameras 1080, to track in real-time objects that are children or look like children. The system flotation units, i.e., water wave detectors 1040 or 1090 are coordinating in real-time with the system video cameras 1080 by fusing their sensory data (large sin(x)/x type wave disturbances, such as event 210 shown in FIG. 2, with video-imaging capture) to determine if a alarm state is to be signaled. If the system flotation units are in the pool, the video cameras 1080 will enter secondary monitor states with the system flotation units 1040 or 1090 will act as primary monitors.

If the video cameras 1080 detect solo recognized child images within the pool perimeter boundary, which implies, no large adult images-in-field of view of system video camera 1080 units, an alarm will be initiated even thought the system flotation units 1040/1090 are in the pool which implies a human supervised state exists. When the system flotation units 1040/1090 are removed from the pool, indicating no more pool activity until the system flotation units 1040/1090 are placed back in the pool, the system video camera 1080 units will not become the primary monitors of the pool perimeter boundary and watching out for child images which indicates a child has breach the pool perimeter boundary and is in danger. This event will result in an alarm condition propagated to all system Alarm nodes.

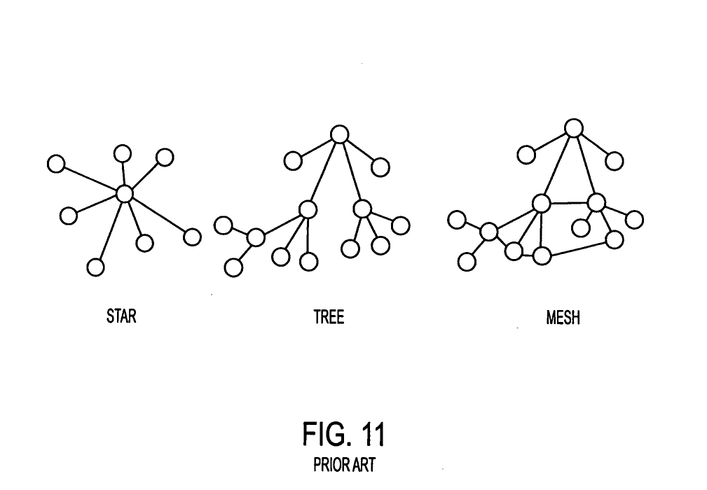

The exemplary system 1000 can operate as described above and be implemented in a variety of network topologies. FIG. 11 illustrates three well-known network topologies that can be used to implement the exemplary embodiments. For example, a star topology, which is a network that has a central system network node, which is linked to all other system network nodes in the system network. All messages travel via the central system network node.

Also shown is a tree topology, which is a system network that has atop system network node with a branch/leaf structure below it. To reach its destination, a message travels up the tree and then down the tree.

The exemplary system is preferably implemented using a mesh topology. In the mesh topology, a system network has a tree-like structure in which some leaves are directly linked. Messages can travel across the tree, when a suitable route is available.

There is one or several system network nodes that coordinate the network of system network nodes. All system network nodes have the role of relaying messages from one neighboring system node to the another. The system network is highly secure, and incorporates measures to prevent intrusion from “jammers” and/or from neighboring system networks. The system allows for access control lists (ACLs) that allow only pre-defined system nodes to join the specific system network system in question. The system, as described above, incorporates 128-bit AES-based encryption, which is a high-security key-based encryption system preventing external agents from interpreting system network data. The system uses message-freshness timers that have timed-out messages rejected, thus preventing message replay attacks on the system network.

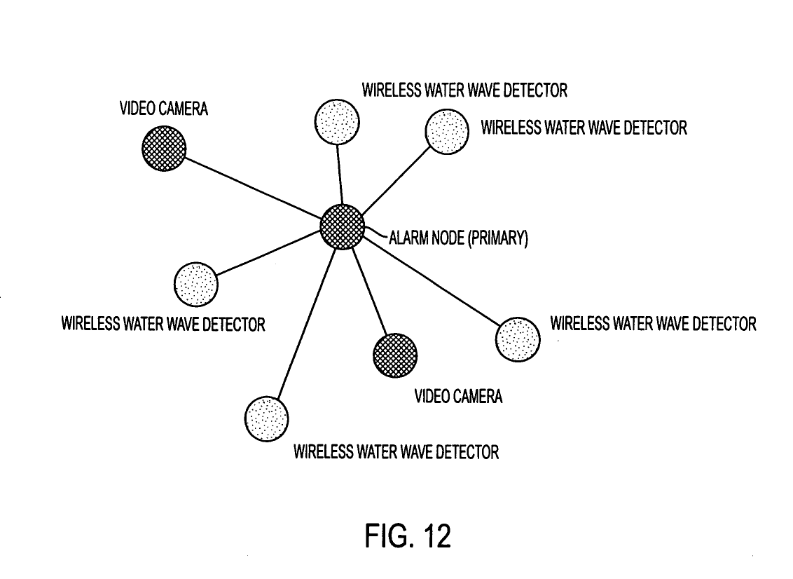

A message in the system comprises acceleration data information, detector device address information, destination address information and other information, if necessary. The way that a message propagates through a system network depends on the system network topology. In all system network topologies, the message will usually pass through one or more intermediate system network nodes before reaching its final system network node destination. The message therefore contains two destination system network addresses which are the system network address of the final system destination node and the address of the system network node which is the next system network node to which the message will be sent or “hop”. The addresses are used in message propagation depends on the system network topology. In the star topology, both system network addresses are needed and the “next hop” address is that of a system network coordinator node as shown in FIG. 12.

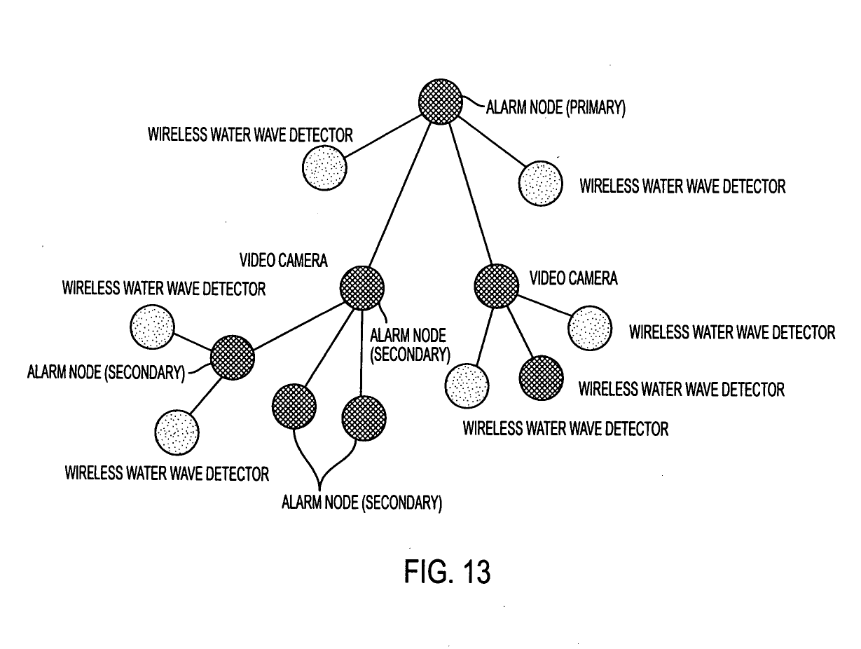

In a system network, which has implemented a tree topology as shown in FIG. 13, both system network addresses are needed and the “next hop” system network address is that of the parent of the sending the system network node. The parent the system network node then resends the message to the next relevant system network node. If this is the target the system network node itself, the “final destination” system network address is used. The last step is then repeated and message propagation continues in this way until the target the system network node is reached.

In a system network, which is configured as a mesh topology, the propagation path depends on whether the target system node is in range. If the system network target node is in range, only the “final destination” system node address is used. If the system network target node is not in range, the “next hop” address is that of the first system node in the route to the final system network destination node. The message propagation continues in this way until the target system network node is reached.

The system supports a “route discovery” facility in which the system network can be requested to find the best available route to a system destination node, when sending a message. system route discovery is initiated when a data transmission request is initiated by a system network node. A route discovery broadcast is sent by the system coordinator node of the source system network node, containing the target system destination node network address. All system coordinator nodes will receive the broadcast, one of which is the system coordinator node of the destination system network node. The system coordinator node of the destination system node sends back a reply addressed to the system coordinator node of the source. As the reply travels back through the system network, the hop count and a signal quality measure for each hop are recorded. Each system coordinator node in the path can build a routing table entry containing the best path to the destination system node. The choice of a best path is usually the one with the least number of hops, although if a hop on the most direct route has a poor signal quality, a route with more hops may be chosen. Each system coordinator node in the path will have a routing table entry and the route from source system node to destination system node is established.

In an alternative embodiment, the same technology can be incorporated into a device, such as a bracelet, that is suitable for wearing by a person, such as person with an illness or handicap that results in frequent falling, seizures, shaking or tremors. The bracelet can provide the same three-dimensional acceleration data that is then compared to historical data gathered when persons experience a fall, a seizure, an episode of shaking or tremors, or similar type of event. The data can also be gathered from the specific person wearing the bracelet, such data can be used on its own or in combination with the historical data, to identify when a person experiences a fall, a seizure, or an episode of shaking or tremors.

In particular, an exemplary apparatus of this embodiment includes a wireless bracelet configured to be located in an area in close proximity to an extremity of a human for measuring acceleration. The human extremity can be a wrist of ankle or a device in proximity to an extremity of a human. The wireless bracelet sends acceleration data using a mesh-type wireless network to a wireless Collector/Analyzer Server for data collection and further processing. The Collector/Analyzer Server performs signal averaging and temporally smoothing of the collected acceleration data using dynamically sized moving average convolution filters and stores the results. Using the stored results, the Collector/Analyzer Server creates differential acceleration time derivatives ([d(Ax)/dt]²+[d(Ay)/dt]²+[d(Az)/dt]²) data, which is used to determine critical events, store these results, and generates any preprogrammed alarms when the it is determined that a critical event has occurred. The Collector/Analyzer Server profiles and correlates the derivative data including critical events with template profiles in memory and measures the correlation, which is also stored for future use and reporting.

The foregoing description is of a preferred embodiment of the invention and has been presented for the purposes of illustration and description of the best mode of the invention currently known to the inventors. This description is not intended to be exhaustive or to limit the invention to the precise form, connections or choice of components disclosed. Obvious modifications or variations are possible and foreseeable in light of the above teachings. This embodiment of the invention was chosen and described to provide the best illustration of the principles of the invention and its practical application to thereby enable one of ordinary skill in the art to utilize the invention in various embodiments and with various modifications as are suited to the particular use contemplated by the inventors.

1. A system for determining the occurrence of abnormal motion of a surface, comprising:
a wireless motion detector for measuring three-dimensional acceleration motion data of the surface and wireless communications channel link energy data;
a transmitter for transmitting the measured data;
a receiver for receiving and storing the data from the wireless motion detector;
a processor for processing the data to determine whether the surface has experienced abnormal motion by signal averaging, temporally smoothing the received data using dynamically sized moving average convolution filters, and comparing the processed data with stored data; and
an output device for outputting an indication of the occurrence of abnormal motion of the surface based on the comparison.

2. The system of claim 1, wherein the wireless motion detector is a water floatation device adaptable to wirelessly transmit data to the server and other wireless, water floatation motion detectors.

3. The system of claim 2, the server comprising:
an RF transceiver configured to receive data from the wireless motion detectors;
a microcontroller processing unit; and
a peripheral communications interface.

4. The system of claim 3, the wireless, water floatation device comprising:
plurality of three-dimensional accelerometers;
a radio frequency transceiver; and
a microcontroller processor unit.

5. The system of claim 4, wherein the radio frequency transceiver of the wireless, water floatation device and the server are compliant with any one of IEEE 802.15.4, BlueTooth, or IEEE 802.11.

6. The system of claim 1, wherein the wireless motion detector is a bracelet wearable by a human adaptable to wirelessly communicate with the server and other wireless motion detectors.

7. The system of claim 1, comprising:
a video camera focused on the perimeter surrounding the surface;
a video camera interface for transferring image data collected by the video camera to the processor, wherein the processor processes the transferred image data and compares the processed image data to previously processed image reference data; and
a memory for storing the processed image data;

8. The system of claim 7, comprising an alarm signal transmitted from the processor based on the comparison of the processed image data to previously processed image reference data.

9. A method for detecting entry of a person into a body of water by determining a condition of the water that indicates the entry of a person into the body of water, comprising:
measuring the three dimensional acceleration data of a device in the body of water and the wireless water wave device communications channel link energy;
transmitting the measured acceleration data to a processor;
processing the transmitted data by signal averaging and temporally smoothing the transmitted acceleration data using dynamically sized moving average convolution filters;
creating differential acceleration time derivatives from the processed data;
comparing the created differential acceleration time derivatives to historical profiles including differential acceleration time derivatives that relate to conditions that indicate the entry of a person into a body of water; and
providing an indication of the entry of a person into the body of water based on the comparison.

10. The method of claim 9, comprising:
detecting swimmer body sizes and their number, wherein adults compared to children for the proposes of determining if the swimming pool perimeter boundary breach is a child or adult, and if the child is alone.

11. The system of claim 9, wherein the system is implemented using a dynamic mesh-network topology for creating a multi-node monitoring environment that is only limited by the network node address set of the underlying network infrastructure and the number of nodes implemented for monitoring swimming pool activity.
